(19) United States
(12) Patent Application Publication
(10) Pub. No.: US 2026/0135701 A1
(43) Pub. Date: May 14, 2026

(54) SECURE SECRETS FOR ENCRYPTION CONSISTENCY

(71) Applicant: Microsoft Technology Licensing, LLC, Redmond, WA (US)

(72) Inventors: Alexander Stephen TOMLIN, Kirkland, WA (US); Gurshan Singh GHUMMAN, Chantilly, VA (US); Robert Edwin BELTER, Kent, WA (US)

(21) Appl. No.: 18/945,369

(22) Filed: Nov. 12, 2024

(51) Int. Cl. H04L 9/08; H04L 9/32

(52) U.S. Cl. CPC H04L 9/088; H04L 9/3263

(57) ABSTRACT

Providing secure secrets for encryption consistency enables rotating security measures (e.g., encryption access keys in users' certificate) for encrypted data at rest, without either needing to retain any prior certificates or requiring decryption and re-encryption. This provides enhanced security over some prior art methods (old keys may be discarded) and enhanced speed over the other prior art methods (no decryption/re-encryption needed). Examples generate a primary encryption key, which is retained on a secure remote computing node, such as in a key vault, and is not shared outside the key vault. Access to the primary encryption key is restricted to users who possess the current encryption access key, which is rotated on some trigger event. The remote node receives incoming messages to encrypt or decrypt files and performs the encryption/decryption using the primary - but only if a message contains the current encryption access key. Rotating the encryption access key preserves security.

### BACKGROUND

The effectiveness of encryption for data at rest is generally limited by the effectiveness of the key management. A recognized good practice for encryption-based data security is rotation of the encryption/decryption key, whether symmetric encryption is used (the encryption key is the decryption key or public key encryption is uses (different keys are used as a pair, one for encryption and the other for decryption). Some encryption schemes encrypt/decrypt data files with a primary encryption key (or key pair) and then encrypt the primary encryption key with a second encryption key. This second encryption key may be referred to as an access key, because it allows access to the primary encryption key, and may be within a user certificate.

Unfortunately, rotation of encryption keys, which means changing the keys on some trigger event such as a timer or a user-initiated event, typically requires one of two approaches for already-existing (and thus previously-encrypted) data files. One is that all decryption keys for those data files must be retained, which diminishes the security value of key rotation. Another is that all of the data files are decrypted with the old key and then re-encrypted with the new key. Although this second approach preserves security, it can be burdensome when the number and/or sizes of the already-existing data files is large.

### SUMMARY

The disclosed examples are described in detail below with reference to the accompanying drawing figures listed below. The following summary is provided to illustrate some examples disclosed herein.

Solutions disclosed herein provide secure secrets for encryption consistency. Examples generate, on a remote computing node, a primary encryption key operable for encrypting data; generate an encryption access key for encrypting the primary encryption key; rotate, on trigger events, the encryption access key; share, among the remote computing node and a user computing node, the rotated encryption access keys; associate, on the remote computing node, the primary encryption key with a current one of the rotated encryption access keys, wherein the primary encryption key is securely retained on the remote computing node and is not shared with the user computing node; and restrict access to the primary encryption key based on at least the current one of the rotated encryption access keys.

Additional examples generate, on the user computing node, an encryption message comprising the encryption access key and identifying a cleartext file to encrypt, wherein the encryption access key is the current one of the rotated encryption access keys; transmit the encryption message to the remote computing node across the computer network; based on at least authenticating the encryption message using the encryption access key, encrypt, by the remote computing node, the cleartext file into a ciphertext file using the primary encryption key, without disclosing the primary encryption key to the user computing node; and either: transmit, from the remote computing node to the user computing node, the ciphertext file; or transmit, from the remote computing node to the user computing node, an indication that encryption is complete.

Additional examples generate, on the user computing node, a decryption message comprising the encryption access key and identifying a ciphertext file to decrypt, wherein the encryption access key is the current one of the rotated encryption access keys; transmit the decryption message to the remote computing node across the computer network; based on at least authenticating the decryption message using the encryption access key, decrypt, by the remote computing node, the ciphertext file into a cleartext file using the primary decryption key, without disclosing the primary decryption key to the user computing node; and either: transmit, from the remote computing node to the user computing node, the cleartext file; or transmit, from the remote computing node to the user computing node, an indication that decryption is complete.

### BRIEF DESCRIPTION OF THE DRAWINGS

The disclosed examples are described in detail below with reference to the accompanying drawing figures listed below:

FIG. 1 illustrates an example architecture that advantageously provides secure secrets for encryption consistency;

FIG. 2 illustrates an exemplary encryption message, as may be used by examples of the architecture of FIG. 1;

FIG. 3 illustrates an exemplary decryption message, as may be used by examples of the architecture of FIG. 1;

FIGS. 4A, 4B, 4C, and 4D show flowcharts illustrating exemplary operations that may be performed when using example architectures, such as the architecture of FIG. 1;

FIGS. 5A, 5B, and 5C show additional flowcharts illustrating exemplary operations that may be performed when using example architectures, such as the architecture of FIG. 1; and

FIG. 6 shows a block diagram of an example computing device suitable for implementing some of the various examples disclosed herein.

Corresponding reference characters indicate corresponding parts throughout the drawings.

### DETAILED DESCRIPTION

Providing secure secrets for encryption consistency enables rotating security measures (e.g., encryption access keys in users'certificate) for encrypted data at rest, without either needing to retain any prior certificates or requiring decryption and re-encryption. This provides enhanced security over some prior art methods (old keys may be discarded) and enhanced speed over the other prior art methods (no decryption/re-encryption needed). Examples generate a primary encryption key, which is retained on a secure remote computing node, such as in a key vault, and is not shared outside the key vault. Access to the primary encryption key is restricted to users who possess the current encryption access key, which is rotated on some trigger event. The remote node receives incoming messages to encrypt or decrypt files and performs the encryption/decryption using the primary - but only if a message contains the current encryption access key. Rotating the encryption access key preserves security.

The encryption and decryption is provided as a service to users without ever exposing the primary encryption key. The primary encryption key remains within a secure key vault on a remote computing node. The encryption access key, which is possessed by the user, is the key that requires rotation. For example, if the user belongs to a set of multiple users, when that user leaves (e.g., leaves a company to change jobs), this may be a trigger event to rotate the encryption access key. The remaining users within the set of multiple users receive the new (current) encryption access key and so are able to continue accessing the primary encryption/decryption key to decrypt data files. However, if the user, who had left the set of multiple users, attempts to use the prior encryption access key, that user is denied access to the primary encryption/decryption key and so is unable to decrypt data files.

Aspects of the disclosure solve multiple problems that are necessarily rooted in computer technology, and render computing platforms more secure and/or and responsive to user needs, by providing the practical result of enabling more rapid key rotation without the need to retain prior keys. These advantageous results are accomplished, at least in part, by associating, on a remote computing node, a primary encryption key with a current one of rotated encryption access keys, wherein the primary encryption key is securely retained on the remote computing node and is not shared with the user computing node; and restricting access to the primary encryption key based on at least the current one of the rotated encryption access keys.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

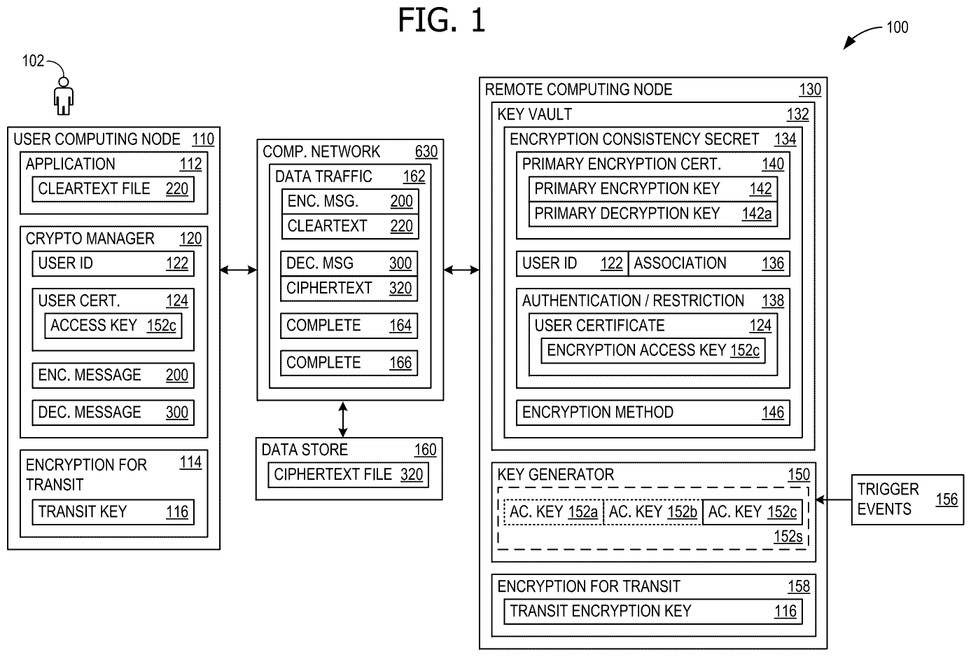

FIG. 1 illustrates an example architecture 100 that advantageously provides secure secrets for encryption consistency. A user 102 is working on a cleartext file 220 using an application 112 on a user computing node 110. Cleartext file 220 may be a word processing document, a spreadsheet, software code, or any other type of computer file, and application 112 is whatever type of software application useful to user 102 for the work.

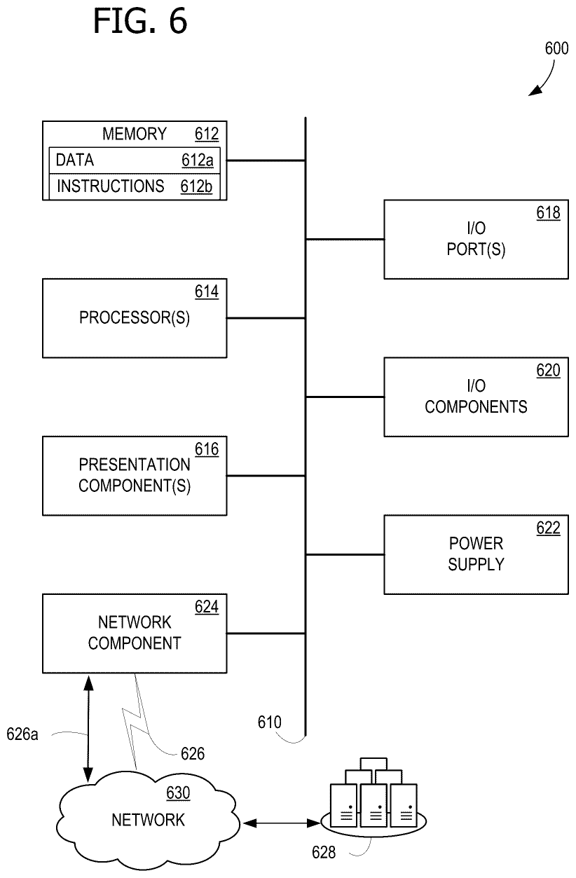

User 102 uses a key vault 132 on a remote computing node 130 to either encrypt cleartext file 220 into a ciphertext file 320 for storage (i.e., encrypted data at rest) and to decrypt ciphertext file 320 into cleartext file 220 in order to operate on cleartext file 220 using application 112. Ciphertext file 320 may be stored locally within user computing node 110, or in a data store 160. In some examples, a secure portion of data store 160 is provided for cleartext file 220 when it is being operated upon by application 112 (e.g., if application 112 executes remotely from user 102). Remote computing node 130 is located across a computer network 630 from user computing node 110. Computer network 630 is described in further detail in relation to FIG. 6.

User 102 accesses key vault 132 on remote computing node 130 using a cryptographic manager 120 on user computing node 110, and an encryption for transit component 114 that encrypts/decrypts data traffic 162 that is sent to/from remote computing node 130. Encryption for transit component 114 uses a transit encryption key 116 that may be a symmetric encryption key or a public key pair. Remote computing node 130 has a corresponding encryption for transit component 158 that also uses transit encryption key 116.

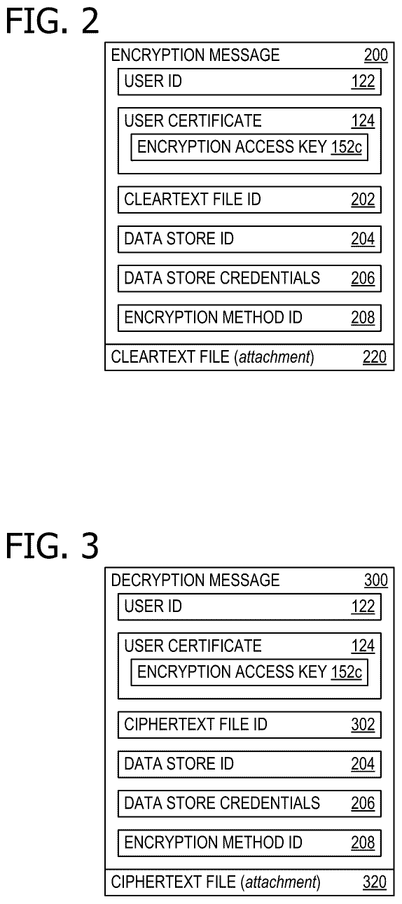

Cryptographic manager 120 generates an encryption message 200 to request that key vault 132 on remote computing node 130 encrypt cleartext file 220 into ciphertext file 320 for storage. Cryptographic manager 120 also generates a decryption message 300 to request that key vault 132 on remote computing node 130 decrypt ciphertext file 320 into cleartext file 220 so that user 102 is able to work on cleartext file 220. Encryption message 200 is shown in further detail in FIG. 2, and decryption message 300 is shown in further detail in FIG. 3.

In order to generate encryption message 200 and decryption message 300, cryptographic manager 120 has a user identifier (ID) 122 that identifies user 102 and a user authentication certificate 124 that user 102 uses to authenticate to key vault 132. User authentication certificate 124 holds the current version of an encryption access key 152c that is uses to access a primary encryption key 142 (and a primary decryption key 142a if the primary decryption key is part of a key pair and is not the same as primary encryption key 142). Primary encryption key 142 is the encryption key that is used to encrypt cleartext file 220 into ciphertext file 320. Primary decryption key 142a (which may be primary encryption key 142 in some examples) is used to decrypt ciphertext file 320 into cleartext file 220.

Primary encryption key 142 and primary decryption key 142a are (is) never shared with user 102, user computing node 110, or data store 160. User 102 and user computing node 110 only have access to user authentication certificate 124 and the different ones of rotated encryption access keys 152s (at various times), which includes (at one time, as illustrated) current encryption access key 152c. In some examples, user authentication certificate 124 is not used, rather only encryption access key 152s are used without a user authentication certificate.

Remote computing node 130 hosts key vault 132, which uses an encryption consistency secret 134 for the advantageous operations described herein. Encryption consistency secret 134 has a primary encryption certificate 140 that holds primary encryption key 142 and primary decryption key 142a (if a key pair is used, otherwise primary encryption key 142 functions as the primary decryption key). Encryption consistency secret 134 also has a copy of user ID 122 in order to recognize user 102. An association 136 of primary encryption certificate 140 with user authentication certificate 124 enables recognition of incoming encryption message 200 and decryption message 300 as being user 102 requesting access to primary encryption key 142 or primary decryption key 142a.

An authentication/restriction component 138 authenticates encryption message 200 and decryption message 300 as being from user 102, by comparing incoming encryption access key 152c (within encryption message 200 or decryption message 300) with a local copy of encryption access key 152c that may be within a local copy of user authentication certificate 124. Authentication/restriction component 138 restricts access to primary encryption key 142 and primary decryption key 142a based on whether the incoming encryption message 200 or decryption message 300 contains the correct encryption access key 152c. In some examples, this takes the form of primary encryption key 142 and primary decryption key 142a being encrypted by encryption access key 152c for storage, such that primary encryption key 142 and primary decryption key 142a can only be decrypted to the proper key value for use when encryption access key 152c is correct (i.e., is the same key or in the same key pair as was used to encrypt primary encryption key 142 and primary decryption key 142a for storage).

If access to primary encryption key 142 or primary decryption key 142a is granted, an encryption method 146 is used to perform the encryption/decryption process on cleartext file 220 or ciphertext file 320. Otherwise, in some examples, if an attempt is made to access primary encryption key 142 or primary decryption key 142a without the correct encryption access key 152c, authentication/restriction component 138 generates an alert to report an improper access attempt.

A key generator 150 generates primary encryption key 142, and primary decryption key 142a if a primary key pair is used. Key generator 150 also generates transit encryption key 116 and the rotated encryption access keys 152s. Three encryption access keys are illustrated, although some examples may have a larger number. An encryption access key 152a is the initial encryption access key, and is replaced by an encryption access key 152b upon rotation. Similarly, encryption access key 152b is replaced by the current (as illustrated) encryption access key 152c.

Encryption access key 152a and encryption access key 152b are shown in dotted lines to indicate that they may be deleted and do not need to be retained after key rotation to encryption access key 152c - even if cleartext file 220 had been encrypted into ciphertext file 320 when encryption access key 152a was the current encryption access key, and user is only just now attempting to decrypt ciphertext file 320 into cleartext file 220 now that encryption access key 152c is the current encryption access key. Further, during the key rotations from encryption access key 152a to encryption access key 152b, and then to encryption access key 152c, there was no need to decrypt and re-encrypt ciphertext file 320.

Key rotations may occur on trigger events 156, such as periodic timer events (e.g., every 90 days or another schedule) and user-defined trigger events (e.g., an authorized user departing or a suspected data security event). Transit encryption key 116 may be rotated on its own trigger events that are relevant to threats to computer network 630.

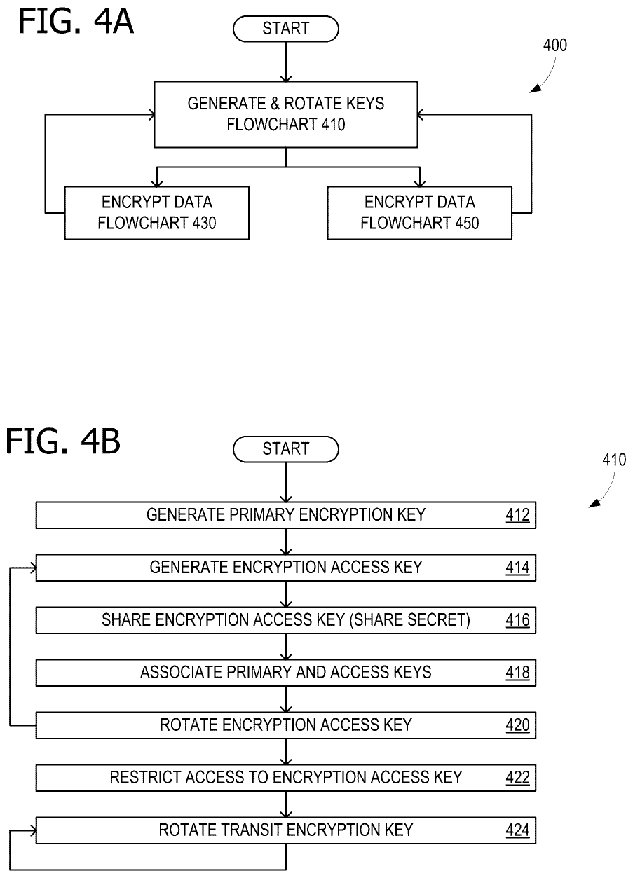

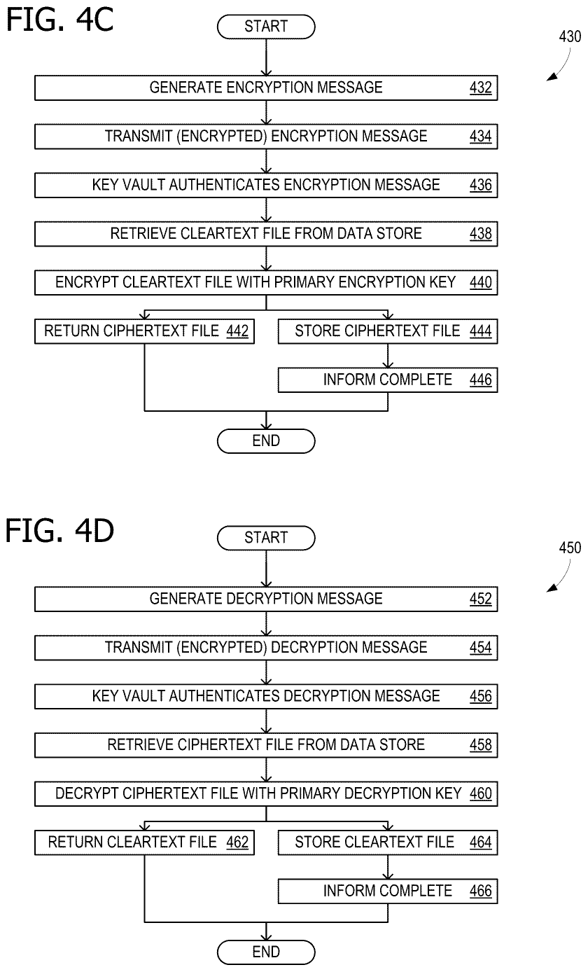

Data traffic 162 across computer network 630, between user computing node 110 and remote computing node 130 is shown as including encryption message 200, decryption message 300, and other messaging from remote computing node 130 to user computing node 110. In some examples, cleartext file 220 is attached to encryption message 200 and/or ciphertext file 320 are attached to decryption message 300, rather than the data files being pulled from data store 160. In some examples, cleartext file 220 and/or ciphertext file 320 are attached to decryption message 300, rather than the data files being sent to data store 160. Messaging from remote computing node 130 includes an indication 164 that encryption is complete and an indication 166 that encryption is complete, which are described in further detail in relation to FIGS. 4C and 4D.

FIG. 2 illustrates an example of encryption message 200, which has user ID 122 and user authentication certificate 124 containing encryption access key 152c. Some examples include just encryption access key 152c, rather than user authentication certificate 124. Some examples have cleartext file 220 as an attachment to encryption message 200, although some examples have an identification 202 of cleartext file 220 and an identification 204 of data store 160 where cleartext file 220 is located. Some examples further include access credentials 206 for data store 160, so that encryption consistency secret 134 in key vault 132 on remote computing node 130 has the same privileges to retrieve cleartext file 220 as does user 102. If key vault 132 uses more than just a single encryption method, encryption message 200 may also contain an identification 208 of encryption method 146, so that the proper encryption is used.

FIG. 3 illustrates an example of decryption message 300, which has user ID 122 and user authentication certificate 124 containing encryption access key 152c. Some examples include just encryption access key 152c, rather than user authentication certificate 124. Some examples have ciphertext file 320 as an attachment to decryption message 300, although some examples have an identification 302 of ciphertext file 320 and an identification 204 of data store 160 where ciphertext file 320 is located. Some examples further include access credentials 206 for data store 160, so that encryption consistency secret 134 in key vault 132 on remote computing node 130 has the same privileges to retrieve ciphertext file 320 as does user 102. If key vault 132 uses more than just a single encryption method, decryption message 300 may also contain an identification 208 of encryption method 146, so that the proper decryption is used.

FIG. 4A shows a flowchart 500 illustrating the relationships of flowcharts 410, 430, and 450 of FIGS. 4B, 4C, and 4D. In some examples, operations described for flowcharts 400, 410, 430, and 450 are performed by computing device 600 of FIG. 6. Flowchart 400 of FIG. 4A commences with flowchart 410 of FIG. 4B, which generates and rotates keys. Upon the keys becoming available, flowchart 430 of FIG. 4C is used when user 102 encrypts cleartext file 220 into ciphertext file 320, and flowchart 450 of FIG. 4D is used when user 102 decrypts ciphertext file 320 into cleartext file 220. Key rotation in flowchart 400 remains ongoing.

Flowchart 410 of FIG. 4B commences with generating primary encryption key 142 on remote computing node 130 in operation 412. In some examples, primary encryption key 142 comprises a symmetric encryption key useable for file decryption, such that primary encryption key 142 also comprises primary decryption key 142a. In some examples, generating primary encryption key 142 comprises generating a primary encryption key pair comprising primary encryption key 142 and a different key as primary decryption key 142a. In such examples, a file encrypted using primary encryption key 142 may be decrypted using primary decryption key 142a. In some examples, primary encryption key 142 is within primary encryption certificate 140.

Operation 414 generates an encryption access key and places the current one within user authentication certificate 124. Encryption access key 152c is current as shown, although encryption access keys 152a and 152b had been current at earlier times. Operation 416 shares the current encryption access key 152c among remote computing node 130 and user computing node 110. At various times, each of rotated encryption access keys 152s is shared in operation 416, when it is the current one. An encryption access key may be generated on remote computing node 130, such as by key generator 150, or on user computing node 110, or elsewhere. Operation 416 includes encrypting data traffic 162, between remote computing node 130 and user computing node 110, using transit encryption key 116, such as the sharing of user authentication certificate 124.

Operation 418 associates primary encryption key 142 with the current one of rotated encryption access keys 152s (e.g., encryption access key 152c), so that when an incoming message requesting encryption or decryption is received, containing encryption access key 152c, key vault 132 knows which primary key to use. Primary encryption key 142 and primary decryption key 142a are securely retained on remote computing node 130 and neither is shared with user computing node 110 (or anywhere outside key vault 132).

Operation 420 rotates current encryption access key 152c on trigger events 156, and flowchart 410 cycles continuously through operations 414-420. In some examples, trigger events 156 comprise periodic timer events (e.g., no less often than every 90 days) and/or user-defined trigger events, such as include changes in user privileges (one user of a setoff users departing) and suspected security compromises. Operation 422 restricts access to primary encryption key 142 based on at least the current one of the rotated encryption access keys. In some examples, this comprises authenticating encryption message 200 using current encryption access key 152c, or authenticating decryption message 300 using current encryption access key 152c, or reporting access attempts to primary encryption key 142 without current encryption access key 152c. In some examples, restricting access to primary encryption key 142 based on the current one of rotated encryption access keys 152s comprises encrypting primary encryption key 142 using the current one of rotated encryption access keys 152s. Operation 424 rotates and distributes transit encryption key 116.

Flowchart 430 of FIG. 4C commences with generating encryption message 200 on user computing node 110 in operation 432. Encryption message 200 comprises current encryption access key 152c and identifies cleartext file 220 to encrypt. Current encryption access key 152c is the current one of rotated encryption access keys 152s. In some examples, encryption message 200 further comprises user ID 122 and/or identifies encryption method 146. In some examples, encryption message 200 further identifies data store 160 and/or comprises access credentials 206 for data store 160. In some examples, cleartext file 220 is located on user computing node 110, and cleartext file 220 is identified using its attachment to encryption message 200. In some examples, cleartext file 220 is identified in encryption message 200, but located elsewhere, such as in data store 160.

Encryption message 200 is transmitted to remote computing node 130 across computer network 630 in operation 434. In some examples, operation 434 includes encrypting data traffic 162 (here, encryption message 200 and possibly cleartext file 220), between remote computing node 130 and user computing node 110, using transit encryption key 116. In operation 436, key vault 132 on remote computing node 130 authenticates encryption message 200 using current encryption access key 152c.

In examples, in which cleartext file 220 is located in data store 160 and cleartext file 220 is identified in encryption message 200, remote computing node 130 retrieves cleartext file 220 from data store 160 in operation 438. In operation 440, remote computing node 130 encrypts cleartext file 220 into ciphertext file 320 using primary encryption key 142, based on at least authenticating encryption message 200 using current encryption access key 152c. Key vault 132 on remote computing node 130 does not ever disclose primary encryption key 142 to user computing node 110, or anywhere else.

In some examples of flowchart 430, operation 442 transmits ciphertext file 320 from remote computing node 130 to user computing node 110. This may include encrypting data traffic 162 (here, ciphertext file 320), between remote computing node 130 and user computing node 110, using transit encryption key 116. Alternatively (or in addition) ciphertext file 320 is stored in data store 160 in operation 444, and remote computing node 130 transmits indication 164 that encryption is complete to user computing node 110, in operation 446. Operation 446 may include encrypting data traffic 162 (here indication 164), between remote computing node 130 and user computing node 110, using transit encryption key 116.

Flowchart 450 of FIG. 4D commences with generating decryption message 300 on user computing node 110 in operation 452. Decryption message 300 comprises current encryption access key 152c and identifies ciphertext file 320 to decrypt. In some examples, decryption message 300 further comprises user ID 122 and/or identifies encryption method 146. In some examples, decryption message 300 further identifies data store 160 and/or comprises access credentials 206 for data store 160. In some examples, ciphertext file 320 is located on user computing node 110, and ciphertext file 320 is identified using its attachment to decryption message 300. In some examples, ciphertext file 320 is identified in decryption message 300, but located elsewhere, such as in data store 160.

Decryption message 300 is transmitted to remote computing node 130 across computer network 630 in operation 454. In some examples, operation 454 includes encrypting data traffic 162 (here, decryption message 300 and possibly ciphertext file 320), between remote computing node 130 and user computing node 110, using transit encryption key 116. In operation 456, key vault 132 on remote computing node 130 authenticates decryption message 300 using current encryption access key 152c.

In examples, in which ciphertext file 320 is located in data store 160 and ciphertext file 320 is identified in decryption message 300, remote computing node 130 retrieves ciphertext file 320 from data store 160 in operation 458. In operation 460, remote computing node 130 decrypts ciphertext file 320 into cleartext file 220 using primary decryption key 142a (which is the same as primary encryption key 142 when symmetric encryption is used), based on at least authenticating decryption message 300 using current encryption access key 152c. Key vault 132 on remote computing node 130 does not ever disclose primary decryption key 142a to user computing node 110, or anywhere else.

In some examples of flowchart 450, operation 462 transmits ciphertext file 320 from remote computing node 130 to user computing node 110. This may include encrypting data traffic 162 (here, ciphertext file 320), between remote computing node 130 and user computing node 110, using transit encryption key 116. Alternatively (or in addition) ciphertext file 320 is stored in data store 160 in operation 464, and remote computing node 130 transmits indication 166 that decryption is complete to user computing node 110, in operation 466. Operation 466 may include encrypting data traffic 162 (here indication 166), between remote computing node 130 and user computing node 110, using transit encryption key 116.

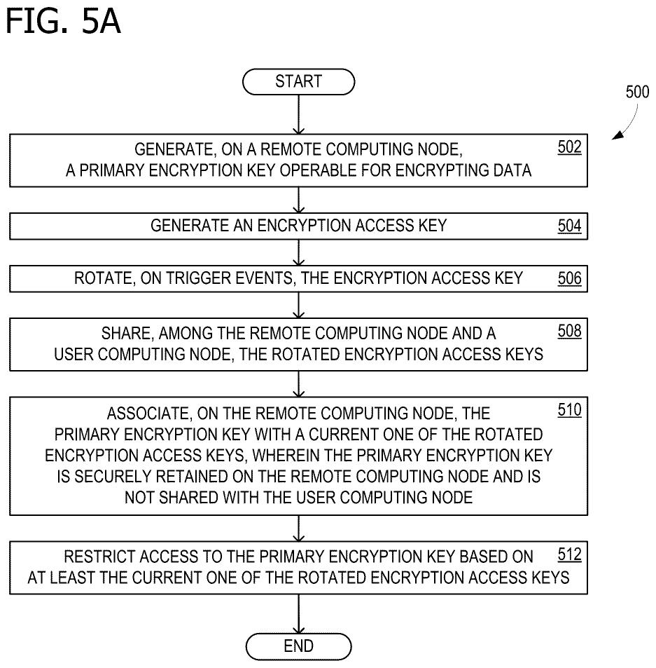

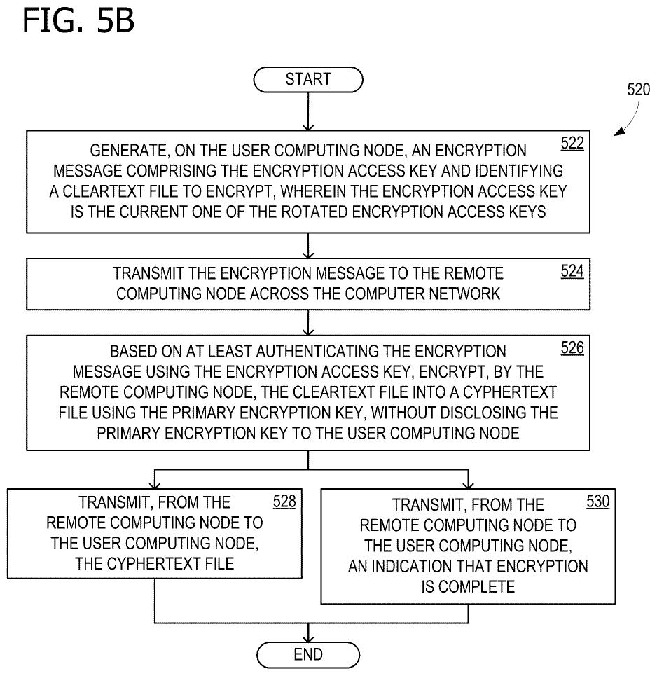

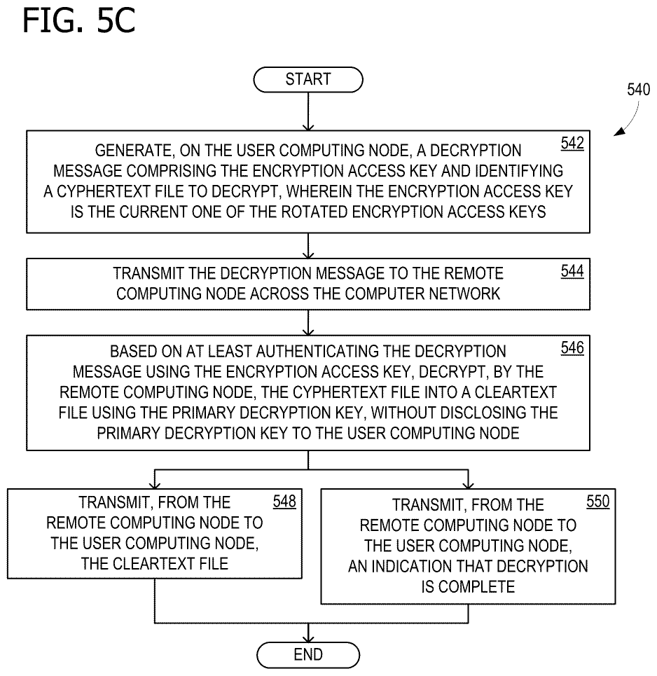

FIG. 5A shows a flowchart 500 illustrating exemplary operations that may be performed by architecture 100. In some examples, operations described for flowchart 500 are performed by computing device 600 of FIG. 6. Flowchart 500 commences with operation 502, which includes generating, on a remote computing node, a primary encryption key operable for encrypting data. Operation 504 includes generate an encryption access key for encrypting the primary encryption key.

Operation 506 includes rotating, on trigger events, the encryption access key. Operation 508 includes sharing, among the remote computing node and a user computing node, the rotated encryption access keys. Operation 510 includes associating, on the remote computing node, the primary encryption key with a current one of the rotated encryption access keys, wherein the primary encryption key is securely retained on the remote computing node and is not shared with the user computing node. Operation 512 includes restricting access to the primary encryption key based on at least the current one of the rotated encryption access keys.

FIG. 5B shows a flowchart 520 illustrating exemplary operations that may be performed by architecture 100. In some examples, operations described for flowchart 520 are performed by computing device 600 of FIG. 6. Flowchart 520 commences with operation 522, which includes generating, on the user computing node, an encryption message comprising the encryption access key and identifying a cleartext file to encrypt, wherein the encryption access key is the current one of the rotated encryption access keys.

Operation 524 includes transmitting the encryption message to the remote computing node across the computer network. Operation 526 includes, based on at least authenticating the encryption message using the encryption access key, encrypting, by the remote computing node, the cleartext file into a ciphertext file using the primary encryption key, without disclosing the primary encryption key to the user computing node. Flowchart 520 then moves to either operation 528 or operation 530. Operation 528 includes transmitting, from the remote computing node to the user computing node, the ciphertext file. Operation 530 includes transmitting, from the remote computing node to the user computing node, an indication that encryption is complete.

FIG. 5C shows a flowchart 540 illustrating exemplary operations that may be performed by architecture 100. In some examples, operations described for flowchart 540 are performed by computing device 600 of FIG. 6. Flowchart 540 commences with operation 542, which includes generating, on the user computing node, a decryption message comprising the encryption access key and identifying a ciphertext file to decrypt, wherein the encryption access key is the current one of the rotated encryption access keys.

Operation 544 includes transmitting the decryption message to the remote computing node across the computer network. Operation 546 includes, based on at least authenticating the decryption message using the encryption access key, decrypting, by the remote computing node, the ciphertext file into a cleartext file using the primary decryption key, without disclosing the primary decryption key to the user computing node. Flowchart 540 then moves to either operation 548 or operation 550. Operation 548 includes transmitting, from the remote computing node to the user computing node, the cleartext file. Operation 550 includes transmitting, from the remote computing node to the user computing node, an indication that decryption is complete.

### Additional Examples

An example system comprises: a processor; and a computer-readable medium storing instructions that are operative upon execution by the processor to: generate, on a remote computing node, a primary encryption key operable for encrypting data; generate an encryption access key for encrypting the primary encryption key; rotate, on trigger events, the encryption access key; share, among the remote computing node and a user computing node, the rotated encryption access keys; associate, on the remote computing node, the primary encryption key with a current one of the rotated encryption access keys, wherein the primary encryption key is securely retained on the remote computing node and is not shared with the user computing node; and restrict access to the primary encryption key based on at least the current one of the rotated encryption access keys.

An example computer-implemented method comprises: generating, on a remote computing node, a primary encryption key operable for encrypting data; generate an encryption access key for encrypting the primary encryption key; rotating, on trigger events, the encryption access key; sharing, among the remote computing node and a user computing node, the rotated encryption access keys; associating, on the remote computing node, the primary encryption key with a current one of the rotated encryption access keys, wherein the primary encryption key is securely retained on the remote computing node and is not shared with the user computing node; and restricting access to the primary encryption key based on at least the current one of the rotated encryption access keys.

One or more example computer storage devices have computer-executable instructions stored thereon, which, on execution by a computer, cause the computer to perform operations comprising: generating, on a remote computing node, a primary encryption key operable for encrypting data; generate an encryption access key for encrypting the primary encryption key; rotating, on trigger events, the encryption access key; sharing, among the remote computing node and a user computing node, the rotated encryption access keys; associating, on the remote computing node, the primary encryption key with a current one of the rotated encryption access keys, wherein the primary encryption key is securely retained on the remote computing node and is not shared with the user computing node; and restricting access to the primary encryption key based on at least the current one of the rotated encryption access keys.

Alternatively, or in addition to the other examples described herein, examples include any combination of the following:
generating, on the user computing node, an encryption message comprising the encryption access key and identifying a cleartext file to encrypt;
the encryption access key is the current one of the rotated encryption access keys;
transmitting the encryption message to the remote computing node across the computer network;
based on at least authenticating the encryption message using the encryption access key, encrypting, by the remote computing node, the cleartext file into a ciphertext file using the primary encryption key, without disclosing the primary encryption key to the user computing node;
transmitting, from the remote computing node to the user computing node, the ciphertext file;
transmitting, from the remote computing node to the user computing node, an indication that encryption is complete;
the cleartext file is located on the user computing node;
the cleartext file is identified using attachment to the encryption message;
the cleartext file is located in a data store;
the cleartext file is identified in the encryption message;
retrieving, by the remote computing node, the cleartext file from the data store;
storing the ciphertext file in the data store;
the primary encryption key comprises a symmetric encryption key useable for file decryption, such that the primary encryption key also comprises a primary decryption key;
generating the primary encryption key comprises generating a primary encryption key pair comprising the primary encryption key and a different key as a primary decryption key;
a file encrypted using the primary encryption key may be decrypted using the primary decryption key;
generating, on the user computing node, a decryption message comprising the encryption access key and identifying a ciphertext file to decrypt;
the encryption access key is the current one of the rotated encryption access keys;
transmitting the decryption message to the remote computing node across the computer network;
based on at least authenticating the decryption message using the encryption access key, decrypting, by the remote computing node, the ciphertext file into a cleartext file using the primary decryption key, without disclosing the primary decryption key to the user computing node;
transmitting, from the remote computing node to the user computing node, the cleartext file;
transmitting, from the remote computing node to the user computing node, an indication that decryption is complete;
the ciphertext file is located on the user computing node;
the ciphertext file is identified using attachment to the decryption message;
the ciphertext file is located in a data store;
the ciphertext file is identified in the decryption message;
retrieving, by the remote computing node, the ciphertext file from the data store;
storing the cleartext file in the data store;
encrypting data traffic, between the remote computing node and the user computing node, using a transit encryption key;
the trigger events comprise periodic timer events and/or user-defined trigger events;
associating the primary encryption key with the current one of the rotated encryption access keys comprises encrypting the primary encryption key using the current one of the rotated encryption access keys;
the encryption message and the decryption message each further comprises a user ID and/or identifies the encryption method;
the encryption message and the decryption message each further identifies the data store and/or comprises the access credentials for the data store;
rotating the transit encryption key;
encrypting the data traffic, between the remote computing node and the user

computing node, comprises using symmetric encryption or public key encryption;
the periodic timer events occur no less often than every 90 days;
the user-defined trigger events include changes in user privileges (a developer leaving) and suspected security compromises;
the primary encryption key is within a primary encryption certificate;
the encryption access key is within a user authentication certificate; and
restricting access to the primary encryption key based on at least the current one of the rotated encryption access keys comprises authenticating the encryption message using the encryption access key, or authenticating the decryption message using the encryption access key, or reporting access attempts to the primary encryption key without the encryption access key.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 6 is a block diagram of an example computing device 600 (e.g., a computer storage device) for implementing aspects disclosed herein, and is designated generally as computing device 600. In some examples, one or more computing devices 600 are provided for an on-premises computing solution. In some examples, one or more computing devices 600 are provided as a cloud computing solution. In some examples, a combination of on-premises and cloud computing solutions are used. Computing device 600 is but one example of a suitable computing environment and is not intended to suggest any limitation as to the scope of use or functionality of the examples disclosed herein, whether used singly or as part of a larger set.

Neither should computing device 600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 610 that directly or indirectly couples the following devices: computer storage memory 612, one or more processors 614, one or more presentation components 616, input/output (I/O) ports 618, I/O components 620, a power supply 622, and a network component 624. While computing device 600 is depicted as a seemingly single device, multiple computing devices 600 may work together and share the depicted device resources. For example, memory 612 may be distributed across multiple devices, and processor(s) 614 may be housed with different devices.

Bus 610 represents what may be one or more buses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 612 may take the form of the computer storage media referenced below and operatively provide storage of computer-readable instructions, data structures, program modules and other data for the computing device 600. In some examples, memory 612 stores one or more of an operating system, a universal application platform, or other program modules and program data. Memory 612 is thus able to store and access data 612a and instructions 612b that are executable by processor 614 and configured to carry out the various operations disclosed herein. Thus, computing device 600 comprises a computer storage device having computer-executable instructions 612b stored thereon.

In some examples, memory 612 includes computer storage media. Memory 612 may include any quantity of memory associated with or accessible by the computing device 600. Memory 612 may be internal to the computing device 600 (as shown in FIG. 6), external to the computing device 600 (not shown), or both (not shown). Additionally, or alternatively, the memory 612 may be distributed across multiple computing devices 600, for example, in a virtualized environment in which instruction processing is carried out on multiple computing devices 600. For the purposes of this disclosure, “computer storage media,” “computer storage memory,” “memory,” and “memory devices” are synonymous terms for the memory 612, and none of these terms include carrier waves or propagating signaling.

Processor(s) 614 may include any quantity of processing units that read data from various entities, such as memory 612 or I/O components 620. Specifically, processor(s) 614 are programmed to execute computer-executable instructions for implementing aspects of the disclosure. The instructions may be performed by the processor, by multiple processors within the computing device 600, or by a processor external to the client computing device 600. In some examples, the processor(s) 614 are programmed to execute instructions such as those illustrated in the flow charts discussed below and depicted in the accompanying drawings. Moreover, in some examples, the processor(s) 614 represents an implementation of analog techniques to perform the operations described herein. For example, the operations may be performed by an analog client computing device 600 and/or a digital client computing device 600. Presentation component(s) 616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 618 allow computing device 600 to be logically coupled to other devices including I/O components 620, some of which may be built in. Example I/O components 620 include, for example but without limitation, a microphone, joystick, game pad, satellite dish, scanner, printer, wireless device, etc.

Computing device 600 may operate in a networked environment via the network component 624 using logical connections to one or more remote computers. In some examples, the network component 624 includes a network interface card and/or computer-executable instructions (e.g., a driver) for operating the network interface card. Communication between the computing device 600 and other devices may occur using any protocol or mechanism over any wired or wireless connection. In some examples, network component 624 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 624 communicates over wireless communication link 626 and/or a wired communication link 626a to a remote resource 628 (e.g., a cloud resource) across a computer network 630. Various different examples of communication links 626 and 626a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are

not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
generate, on a remote computing node, a primary encryption key operable for encrypting data;
generate an encryption access key for encrypting the primary encryption key;
rotate, on trigger events, the encryption access key;
share, among the remote computing node and a user computing node, the rotated encryption access keys;
associate, on the remote computing node, the primary encryption key with a current one of the rotated encryption access keys, wherein the primary encryption key is securely retained on the remote computing node and is not shared with the user computing node; and
restrict access to the primary encryption key based on at least the current one of the rotated encryption access keys.

2. The system of claim 1, wherein the instructions are further operative to:
generate, on the user computing node, an encryption message comprising the encryption access key and identifying a cleartext file to encrypt, wherein the encryption access key is the current one of the rotated encryption access keys;
transmit the encryption message to the remote computing node across a computer network;
based on at least authenticating the encryption message using the encryption access key, encrypt, by the remote computing node, the cleartext file into a ciphertext file using the primary encryption key, without disclosing the primary encryption key to the user computing node; and
either:
transmit, from the remote computing node to the user computing node, the ciphertext file; or
transmit, from the remote computing node to the user computing node, an indication that encryption is complete.

3. The system of claim 2,
wherein the cleartext file is located on the user computing node, and wherein the cleartext file is identified using attachment to the encryption message; or
wherein the cleartext file is located in a data store, wherein the cleartext file is identified in the encryption message, and wherein the instructions are further operative to:
retrieve, by the remote computing node, the cleartext file from the data store; and
store the ciphertext file in the data store.

4. The system of claim 1, wherein the instructions are further operative to:
generate, on the user computing node, a decryption message comprising the encryption access key and identifying a ciphertext file to decrypt, wherein the encryption access key is the current one of the rotated encryption access keys;
transmit the decryption message to the remote computing node across a computer network;
based on at least authenticating the decryption message using the encryption access key, decrypt, by the remote computing node, the ciphertext file into a cleartext file using the primary decryption key, without disclosing the primary decryption key to the user computing node; and
either:
transmit, from the remote computing node to the user computing node, the cleartext file; or
transmit, from the remote computing node to the user computing node, an indication that decryption is complete.

5. The system of claim 4,
wherein the ciphertext file is located on the user computing node, and wherein the ciphertext file is identified using attachment to the decryption message; or
wherein the ciphertext file is located in a data store, wherein the ciphertext file is identified in the decryption message, and wherein the instructions are further operative to:
retrieve, by the remote computing node, the ciphertext file from the data store; and
store the cleartext file in the data store.

6. The system of claim 1,
wherein the primary encryption key comprises a symmetric encryption key useable for file decryption, such that the primary encryption key also comprises a primary decryption key; or
wherein generating the primary encryption key comprises generating a primary encryption key pair comprising the primary encryption key and a different key as a primary decryption key, wherein a file encrypted using the primary encryption key may be decrypted using the primary decryption key.

7. A computer-implemented method comprising:
generating, on a remote computing node, a primary encryption key operable for encrypting data;
generate an encryption access key for encrypting the primary encryption key;
rotating, on trigger events, the encryption access key;
sharing, among the remote computing node and a user computing node, the rotated encryption access keys;
associating, on the remote computing node, the primary encryption key with a current one of the rotated encryption access keys, wherein the primary encryption key is securely retained on the remote computing node and is not shared with the user computing node; and
restricting access to the primary encryption key based on at least the current one of the rotated encryption access keys.

8. The method of claim 7, further comprising:
generating, on the user computing node, an encryption message comprising the encryption access key and identifying a cleartext file to encrypt, wherein the encryption access key is the current one of the rotated encryption access keys;
transmitting the encryption message to the remote computing node across a computer network;
based on at least authenticating the encryption message using the encryption access key, encrypting, by the remote computing node, the cleartext file into a ciphertext file using the primary encryption key, without disclosing the primary encryption key to the user computing node; and
either:
transmitting, from the remote computing node to the user computing node, the ciphertext file; or
transmitting, from the remote computing node to the user computing node, an indication that encryption is complete.

9. The method of claim 8,
wherein the cleartext file is located on the user computing node, and wherein the cleartext file is identified using attachment to the encryption message; or
wherein the cleartext file is located in a data store, wherein the cleartext file is identified in the encryption message, and wherein the method further comprises:
retrieving, by the remote computing node, the cleartext file from the data store; and
storing the ciphertext file in the data store.

10. The method of claim 7, further comprising:
generating, on the user computing node, a decryption message comprising the encryption access key and identifying a ciphertext file to decrypt, wherein the encryption access key is the current one of the rotated encryption access keys;
transmitting the decryption message to the remote computing node across a computer network;
based on at least authenticating the decryption message using the encryption access key, decrypting, by the remote computing node, the ciphertext file into a cleartext file using the primary decryption key, without disclosing the primary decryption key to the user computing node; and
either:
transmitting, from the remote computing node to the user computing node, the cleartext file; or
transmitting, from the remote computing node to the user computing node, an indication that decryption is complete.

11. The method of claim 10,
wherein the ciphertext file is located on the user computing node, and wherein the ciphertext file is identified using attachment to the decryption message; or
wherein the ciphertext file is located in a data store, wherein the ciphertext file is identified in the decryption message, and wherein the method further comprises:
retrieving, by the remote computing node, the ciphertext file from the data store; and
storing the cleartext file in the data store.

12. The method of claim 7,
wherein the primary encryption key comprises a symmetric encryption key useable for file decryption, such that the primary encryption key also comprises a primary decryption key; or
wherein generating the primary encryption key comprises generating a primary encryption key pair comprising the primary encryption key and a different key as a primary decryption key, wherein a file encrypted using the primary encryption key may be decrypted using the primary decryption key.

13. The method of claim 7, further comprising:
encrypting data traffic, between the remote computing node and the user computing node, using a transit encryption key.

14. The method of claim 7, wherein the trigger events comprise periodic timer events and/or user-defined trigger events.

15. The method of claim 7, wherein associating the primary encryption key with the current one of the rotated encryption access keys comprises encrypting the primary encryption key using the current one of the rotated encryption access keys.

16. A computer storage device having computer-executable instructions stored thereon, which, on execution by a computer, cause the computer to perform operations comprising:
generating, on a remote computing node, a primary encryption key operable for encrypting data;
generate an encryption access key for encrypting the primary encryption key;
rotating, on trigger events, the encryption access key;
sharing, among the remote computing node and a user computing node, the rotated encryption access keys;
associating, on the remote computing node, the primary encryption key with a current one of the rotated encryption access keys, wherein the primary encryption key is securely retained on the remote computing node and is not shared with the user computing node; and
restricting access to the primary encryption key based on at least the current one of the rotated encryption access keys.

17. The computer storage device of claim 16, wherein the operations further comprise:
generating, on the user computing node, an encryption message comprising the encryption access key and identifying a cleartext file to encrypt, wherein the encryption access key is the current one of the rotated encryption access keys;
transmitting the encryption message to the remote computing node across a computer network;
based on at least authenticating the encryption message using the encryption access key, encrypting, by the remote computing node, the cleartext file into a ciphertext file using the primary encryption key, without disclosing the primary encryption key to the user computing node; and
either:
transmitting, from the remote computing node to the user computing node, the ciphertext file; or
transmitting, from the remote computing node to the user computing node, an indication that encryption is complete.

18. The computer storage device of claim 17,
wherein the cleartext file is located on the user computing node, and wherein the cleartext file is identified using attachment to the encryption message; or
wherein the cleartext file is located in a data store, wherein the cleartext file is identified in the encryption message, and wherein the operations further comprise:
retrieving, by the remote computing node, the cleartext file from the data store; and
storing the ciphertext file in the data store.

19. The computer storage device of claim 16, wherein the operations further comprise:
generating, on the user computing node, a decryption message comprising the encryption access key and identifying a ciphertext file to decrypt, wherein the encryption access key is the current one of the rotated encryption access keys;
transmitting the decryption message to the remote computing node across a computer network;
based on at least authenticating the decryption message using the encryption access key, decrypting, by the remote computing node, the ciphertext file into a cleartext file using the primary decryption key, without disclosing the primary decryption key to the user computing node; and
either:
transmitting, from the remote computing node to the user computing node, the cleartext file; or
transmitting, from the remote computing node to the user computing node, an indication that decryption is complete.

20. The computer storage device of claim 19,
wherein the ciphertext file is located on the user computing node, and wherein the ciphertext file is identified using attachment to the decryption message; or
wherein the ciphertext file is located in a data store, wherein the ciphertext file is identified in the decryption message, and wherein the operations further comprise:
retrieving, by the remote computing node, the ciphertext file from the data store; and
storing the cleartext file in the data store.
